(19) United States
(12) Patent Application Publication
(10) Pub. No.: US 2024/0256702 A1
(43) Pub. Date: Aug. 1, 2024

(54) ENCRYPTION ORCHESTRATION OF SENSITIVE INFORMATION

(71) Applicant: Amadeus S.A.S., Biot (FR)

(72) Inventors: Yann Matthieu Elie Auguste ARMELIN, Antibes (FR); Clement OLIVA, Valbonne (FR); Nicolas GEX, Antibes (FR); Jean-Louis FELT, Valbonne (FR)

(21) Appl. No.: 18/508,337

(22) Filed: Nov. 14, 2023

(30) Foreign Application Priority Data
Jan. 31, 2023 (EP) 23305123.4

(51) Int. Cl. G06F 21/62; G06F 21/60

(52) U.S. Cl. CPC G06F 21/6245; G06F 21/602

(57) ABSTRACT

Methods, systems, and computer program products for implementing an encryption orchestration of sensitive information process. An application window is provided on an interface on the display during a first session. A first encryption key and a first session identification (ID) associated with the first session is received. Input of a first character string is received at an input field that includes one or more characters, where each character is modified based on an encryption algorithm utilizing the first encryption key associated with the first session ID. The modified characters are provided as a modified input string to the host server, where the host server is configured to decrypt the modified input string based on a decryption algorithm. A second display page is provided on the display in response to receiving access from the host server based on an evaluation of a decryption of the modified input string.

### TECHNICAL FIELD

The present invention generally relates to computers and computer software, and more specifically, to methods, systems, and computer program products for implementing an encryption orchestration of sensitive information process.

### BACKGROUND

In many applications involving the entry of sensitive information (e.g., passwords), an input field may be masked or otherwise concealed during input such that the actual input remains invisible, effectively proscribing an onlooker's ability to read the sensitive information from the input field. In a traditional environment where a complete keyboard is provided, this type of concealment is generally adequate and poses little problem. However, if an onlooker has access to the device/screen while the user is away (e.g., entered the password and did not hit enter and did not lock the screen), the onlooker can inspect the screen and change the type of the field. For example, in some instances, the onlooker could reveal the entered characters (e.g., hover over or click on the “eye” symbol), and then be able to get the sensitive information without anyone knowing it (e.g., the host system), including the user. Additionally, malware from a malicious server may be able to intercept the password before being sent to a host server that the user is trying to access. Thus, when entering in sensitive information, an additional process may be needed to conceal the sensitive information from onlookers who may be able to gain access to the user's device/screen and be able to prevent a malicious server from gaining access to a password before it is encrypted at the receiving site.

One example prior art method for context sensitive concealment of an input field for an electronic communications device, from U.S. Patent Publication No. 2008/0229230A1, is as follows. An electronic communications device may include a plurality of keys, a display upon which a series of characters are adapted to be displayed, the series of characters forming a character string and composed by input operation of a subset of the plurality of keys, and a processor for implementing at least one module that includes at least one security component. The module may receive the series of characters during an entry period, the series of characters forming a character string, the entry period comprised of at least one activity period during which the character string is displayed and one inactivity period during which the character string is obscured. The module may detect an inactivity event during the at least one activity period, the activity period ending when the inactivity event has been detected. The module may detect an activity event during the at least one inactivity period, the inactivity period ending when the activity event has been detected. The module may also detect a completion of composition event, the entry period ending when the composition completion event has been detected and conceal permanently the character string after the entry period ends.

Another example prior art method for hosted sensitive data form fields for compliance with security standards, from International Patent Publication No. WO 2016/191314A1, is as follows. A user may request a web page from an organization, such as a merchant's checkout web page, that requires entry of sensitive data. The merchant's checkout web page may include reference to a script file that provides hosted sensitive data form fields. In response to rendering the merchant web page in a web browser of the user, a request to provide sensitive data form fields on the merchant web page may be received. The request may include a call to a function in a scripting file provided by a third party, and the provided file may cause one or more inline frames to be rendered in the web browser, each inline frame including a sensitive data form field. Data entered by the user in the sensitive data form fields may be received by a third party payment processor device.

Additional background information for password inputs from the Mozilla Foundation is as follows. Password input boxes generally work just like other textual input boxes, but the main difference is the obscuring of the content to prevent people near the user from reading the password. The element is presented as a one-line plain text editor control in which the text is obscured so that it cannot be read, usually by replacing each character with a symbol such as the asterisk (“*”) or a dot (“•”). This character will vary depending on the user agent and operating system. The precise behavior of the entry process may vary from browser to browser. Some browsers display the typed character for a moment before obscuring it, while others allow the user to toggle the display of plain-text on and off. Both approaches help a user check that they entered the intended password, which can be particularly difficult on mobile devices. If your recommended (or required) password syntax rules would benefit from an alternate text entry interface than the standard keyboard, you can use the “inputmode” attribute to request a specific one. The most obvious use case for this is if the password is required to be numeric (such as a PIN). Mobile devices with virtual keyboards, for example, may opt to switch to a numeric keypad layout instead of a full keyboard, to make entering the password easier. If the PIN is for one-time use, set the “autocomplete” attribute to either “off” or “one-time-code” to suggest that it's not saved. If your application has character set restrictions or any other requirement for the actual content of the entered password, you can use the “pattern” attribute to establish a regular expression to be used to automatically ensure that your passwords meet those requirements.

### SUMMARY

In embodiments of the invention, a method for implementing an encryption orchestration of sensitive information process is provided. The method, at an electronic device having a processor and display, includes providing an application window on an interface on the display during a first session, the application window being associated with a host server and including an input field for entry of sensitive information at a first display page of the application window. The method further includes receiving, from the host server, a first encryption key and a first session identification (ID) associated with the first session. The method further includes receiving input of a first character string at the input field, the first character string including one or more characters, where, during the input of each character of the first character string at the input field, each character is modified based on an encryption algorithm utilizing the first encryption key associated with the first session ID. The method further includes providing the modified characters as a modified input string to the host server, wherein the host server is configured to decrypt the modified input string based on a decryption algorithm. The method further includes providing a second display page on the display in response to receiving access from the host server based on an evaluation of a decryption of the modified input string.

These and other embodiments can each optionally include one or more of the following features.

In some embodiments of the invention, during the input of each character of the first character string at the input field, a first modified character is displayed after input of a first character, and after input of a second character a first modified character is displayed and the first modified character is updated.

In some embodiments of the invention, during the input of each character of the character string at the input field, the display of each character in the input field displays a modified character for each character.

In some embodiments of the invention, during a second session different than the first session, the method further includes receiving, from the host server, a second encryption key and a second session ID associated with the second session, wherein the second encryption key is different than the first encryption key, and receiving input of a second character string at the input field, the second character string including one or more characters, wherein, during the input of each character of the second character string at the input field, each character is modified based on the encryption algorithm utilizing the second encryption key associated with the second session ID.

In some embodiments of the invention, the first character string is the same as the second character string, and the modified characters associated with the second character string are different from the modified characters associated with the first character string.

In some embodiments of the invention, the host server is configured to decrypt the modified input string based on the decryption algorithm utilizing a first decipher key associated with the first session ID.

In some embodiments of the invention, during the input of each character of the first character string at the input field, each modified character is displayed. In some embodiments of the invention, during the input of each character of the first character string at the input field, a symbol is displayed to represent each modified character. In some embodiments of the invention, during the input of each character of the first character string at the input field, a symbol is displayed that represents two or more of the modified characters.

In some embodiments of the invention, a computing apparatus including one or more processors, at least one memory device coupled with the one or more processors, and a data communications interface operably associated with the one or more processors, where the memory device contains a plurality of program instructions that, when executed by the one or more processors, cause the computing apparatus to perform the method as described above.

In some embodiments of the invention, a non-transitory computer storage medium encoded with a computer program is provided, where the computer program includes a plurality of program instructions that when executed by one or more processors cause the one or more processors to perform the method as described above.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates an example operating environment for implementing an encryption orchestration of sensitive information process, according to embodiments of the invention.

FIG. 2A illustrates an example encryption and display concealment process that may be performed by a client device within the operating environment shown in FIG. 1, according to embodiments of the invention.

FIG. 2B illustrates an example decryption process that may be performed by a host server within the operating environment shown in FIG. 1, according to embodiments of the invention.

FIG. 3 is a flowchart of an example process for orchestrating encryption of sensitive information, according to embodiments of the invention.

FIG. 4 is a block diagram showing an example computer architecture for a computer capable of executing the software components described herein, according to embodiments described herein.

### DETAILED DESCRIPTION

Generally, systems, methods, devices, and techniques are provided for implementing an encryption orchestration of sensitive information process to conceal sensitive information (e.g., passwords) from unwanted entities (e.g., onlookers, hackers, etc.).

In many applications involving the entry of sensitive information (e.g., passwords), an input field may be masked or otherwise concealed during input such that the actual input remains invisible, effectively proscribing an onlooker's ability to read the sensitive information from the input field. In a traditional environment where a complete keyboard is provided, this type of concealment is generally adequate and poses little problem. However, if an onlooker has access to the device/screen while the user is away (e.g., entered the password and did not hit enter and did not lock the screen), the onlooker can inspect the screen and change the type of the field. For example, in some instances, the onlooker could reveal the entered characters (e.g., hover over or click on the “eye” symbol), and then be able to get the sensitive information without anyone knowing it (e.g., the host system), including the user. Additionally, malware from a malicious server may be able to intercept the password before being sent to a host server that the user is trying to access. Thus, when entering in sensitive information, an additional process may be needed to conceal the sensitive information from onlookers who may be able to gain access to the user's device/screen and be able to prevent a malicious server from gaining access to a password before it is encrypted at the receiving site.

In order to be able to prevent onlookers from stealing a user's password or other sensitive information and prevent malicious servers from accessing the password, the technology in this patent application is related to systems and methods for implementing a sensitive html input field concealment process that encrypts the sensitive information at the user's device and changes the encryption process (e.g., changes the key/cipher) each session. Thus, sensitive data will be concealed at entry at the user's device and would not be accessible by the user or any onlooker. Sensitive data disappears from memory and only the backend/host will be able to access the entered values. For example, if a hacker attempts to view the typed in password, they would only see hashed characters or alternate characters that were modified by the encryption algorithm. Additionally, a technical advantage for the technology in this patent application encrypts the data at user device and host server, such that if a malicious entity (e.g., an attacker) checks a hard drive of the user's electronic device or the host server, he or she will not be able to retrieve the password, because it will be already encrypted at the hard drive.

More specifically, embodiments of the invention may include a process, at an electronic device having a processor and display that provides an application window on an interface on the display during a first session, the application window being associated with a host server and including an input field for entry of sensitive information at a first display page of the application window, and receives, from the host server, a first encryption key and a first session identification (ID) associated with the first session. The process may further include receiving input of a first character string at the input field, the first character string including one or more characters, where, during the input of each character of the first character string at the input field, each character is modified (e.g., encrypted with a public key) based on an encryption algorithm utilizing the first encryption key associated with the first session ID. For example, a user typing in password, using the public key, the displayed web page encrypts the entered character and replaces its value by the concealed result. The modified character may be a sign/character that can comprise one or more of the entered characters (e.g., entry “a” or “abc”, etc. is encrypted as “YQ==” but displayed as “•”). The process may further include providing the modified characters as a modified input string to the host server, wherein the host server is configured to decrypt the modified input string based on a decryption algorithm (e.g., once the user sends the form to the backend, the backend will decode the encrypted value using its private key). The process may further include providing a second display page on the display in response to receiving access from the host server based on an evaluation of a decryption of the modified input string (e.g., accepting the password and granting log in access at the host server).

In some embodiments of the invention, the encryption orchestration of sensitive information process may utilize salt cryptography. In an exemplary embodiment, let's say the user is about to type “AA” into the password (input) field. To initiate the encryption orchestration of sensitive information process, a host server may generate a public and private key, and send the public key to an end user device. When the end user types the first letter “A” as the first part of the password sequence, the end user device may generate a short random string: “xYtxZ” (e.g., the “salt”), concatenate the password character with the salt: “AxYtxZ”, encrypt the “salted” character with the public key: Encrypt(AxYtxZ, publicKey)=“&!F$ùX+”, and save the mapping table: “0: &!F$ùX+” in memory. After user types in “A”, the password/input field may display a symbol: “•”. When the end user types the second letter “A” as the second part of the password sequence, the end user device may then apply a similar process but with a different salt, so it generates a different encrypted string: “!H8_@#K”, and the mapping table in memory is updated to: “0: &!F$ùX+, 1: !H8_@#K”. After user types in the second letter “A”, the password/input field may display two symbols: “••”, to represent the two characters that were entered. The end user may then submit the password entered into the password/input field, and the end user device may send a full mapping table to the host server as a password (e.g., “••” is used only for display on screen). The host server decrypts each character one by one using the private key, and reconstructs the full password, thus only the encrypted information is sent between the end user device and the host device.

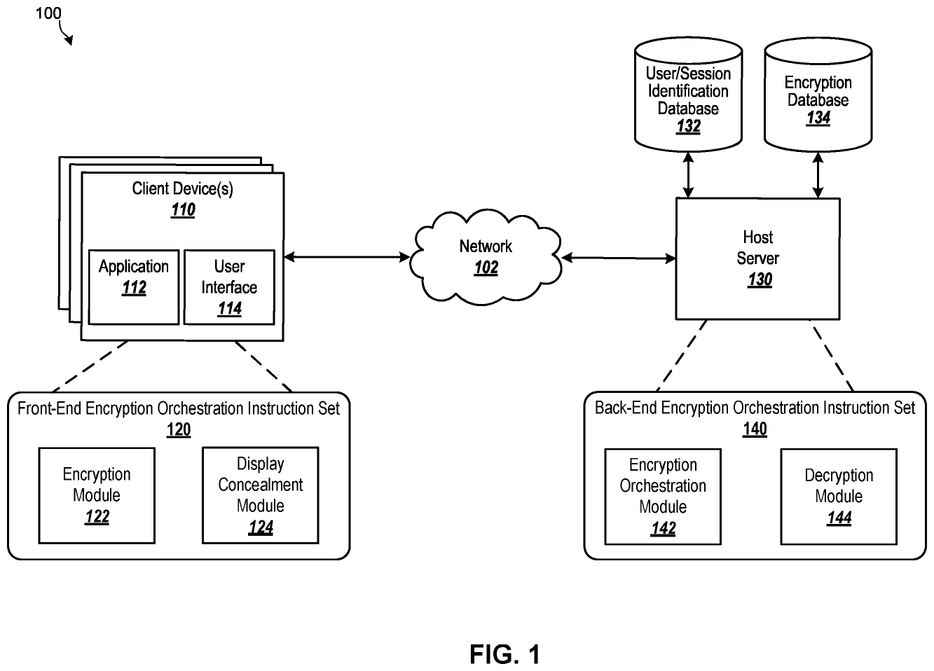

FIG. 1 illustrates an example operating environment 100 for implementing an encryption orchestration of sensitive information process, according to embodiments of the invention. The example environment 100 includes one or more client device(s) 110, and a host server 130 that communicate over a data communication network 102, e.g., a local area network (LAN), a wide area network (WAN), the Internet, a mobile network, or a combination thereof.

A client device 110 can include a desktop, a laptop, a server, or a mobile device, such as a smartphone, tablet computer, wearable device (e.g., smartwatch), in-car computing device, and/or other types of mobile devices. The client device 110 includes applications, such as the application 112, for managing the encryption orchestration process to/from the host server 130. The client device 110 can include other applications. Additionally, the client device 110 includes a display that provides a graphical user interface (GUI) 114. Accordingly, in the event that a user of the client device 110 initiates a session request (e.g., password log in request for a host website or application) via the application 112, corresponding content is generated via the device at user interface 114 and provided at a display of the client device 110.

The application 112 and user interface 114 may be hosted by an application stored on the client device 110 or may be a web browser application. The user interface 114 may be responsive to user input to provide input to the application 112 to engage with the encryption orchestration process. The inputs may include typing or other means of entering one or more characters as part of a password input process, as further discussed herein (e.g., entering a password to enter an application, a web-based application or page, or a portal hosted by the host server 130).

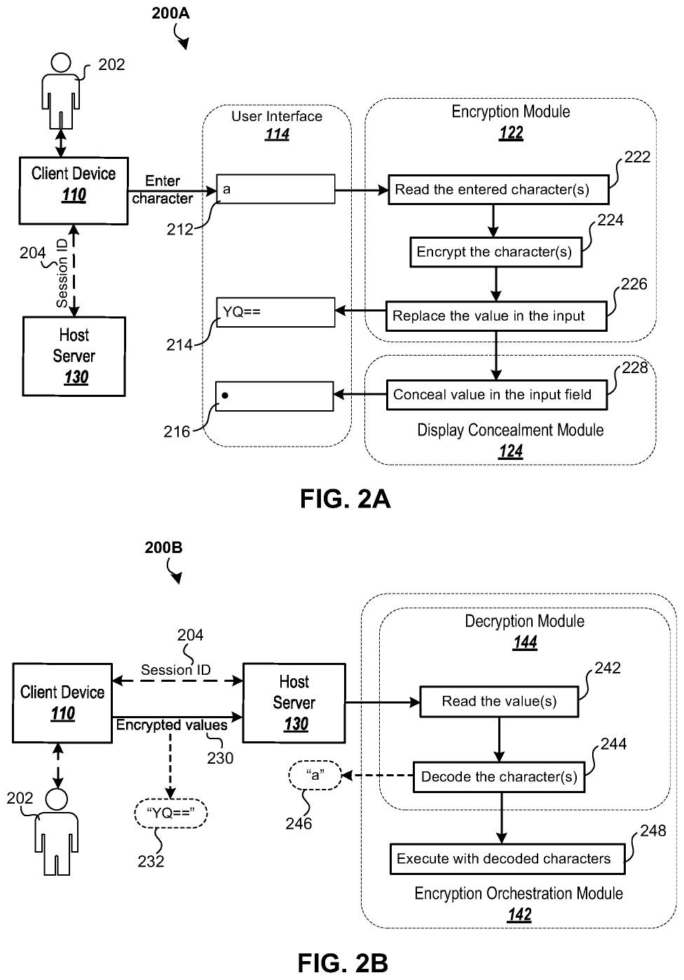

The client device 110 includes a front-end encryption orchestration instruction set 120 that includes an encryption module 122 and a display concealment module 124, according to techniques described herein. In some implementations of the invention, the encryption module 122 may be utilized by the front-end encryption orchestration instruction set 120 to receive and execute a unique encryption protocol based on a session ID received via the host server 130 (e.g., encrypt each character with a unique key/cipher combination that is updated for each user session between the user's device and the host server). In some implementations of the invention, the display concealment module 124 may be utilized by the front-end encryption orchestration instruction set 120 to conceal the display of the typed password at the user interface 114 (e.g., replace the encrypted password or typed in password with a symbol or another character that conceals the identity of the typed in password as well as the encrypted password). The processes of the encryption module 122 and the display concealment module 124 are further discussed herein with reference to the process illustrated in the example environment 200A of FIG. 2A.

The host server 130 manages the encryption orchestration of sensitive information process and communication with application 112 from the one or more client devices 110. The host server 130 includes a back-end encryption orchestration instruction set 140 that includes an encryption orchestration module 142 and a decryption module 144, according to techniques described herein. In some implementations of the invention, the encryption orchestration module 142 may be utilized by the back-end encryption orchestration instruction set 140 to execute the encryption orchestration of sensitive information process for the host server 130 to identify a user of the client device, determine whether to initiate encryption orchestration process, and/or determine a session ID (e.g., determine whether this is a new session or a subsequent session that would require a different/unique encryption protocol that is different than a prior used encryption protocol, etc.). In some implementations of the invention, the decryption module 144 may be utilized by the back-end encryption orchestration instruction set 140 to receive and execute a unique decryption protocol based on a session ID (e.g., decrypt the encrypted password with the unique key that is associated with a session ID). The processes of the encryption orchestration module 142 and a decryption module 144 are further discussed herein with reference to the process illustrated in the example environment 200B of FIG. 2B.

The host server 130 may be a front-end server for managing, collecting, processing, and communicating session ID data, user ID information, encrypted passwords, resource information, etc., from one or more other sources (e.g., a back-end gateway for multiple other servers associated with one or more different entities, such as one or more merchant servers). Additionally, the host server 130 can store some or all of the user ID data and session ID in a user/session identification database 132 and/or store the encryption information in an encryption database 134. In some implementation of the invention, the user ID data and session ID information from the user/session identification database 132 and/or the encryption information in an encryption database 134 may also be accessed by the application 112 on the client device 110.

An example of implementing an encryption orchestration of sensitive information process as illustrated in the environment of FIG. 1 is further discussed herein with reference to FIGS. 2A and 2B.

FIG. 2A illustrates an example environment 200A for an encryption and display concealment process that may be performed by a client device within the operating environment shown in FIG. 1, according to embodiments of the invention. In particular, the example environment 200A provides a process to conceal sensitive information in order to be able to prevent onlookers from stealing a user's password or other sensitive information and prevent malicious servers from accessing the password when being sent to a host server 130. The process involves encryption on the front end (e.g., the client device 110) that encrypts each character with a unique key/cipher combination that is updated for each user session between the user's device and the host server. For example, as illustrated in FIG. 2A, when a user 202 accesses a host's application (e.g., via application 112), the host server 130 may provide a session ID 204 that identifies a first user session (e.g., based on user information, client device 110 information such as an IP address, a time stamp for access, and the like). The client device 110 then provides the user 202 with an input field 212 to enter the password (or other sensitive information). The user then enters one or more characters at the input field 212 of the user interface 114 (e.g., user 202 enters the first letter of his or her password: “a” at the input field 212). The encryption module 122 receives the entered character(s) at block 222 and encrypts the one or more character(s) based on a unique encryption key and cipher combination associated with the session ID received from the host server 130 at block 224. At block 226, the encryption module 122 replaces the values to be displayed in the input field 214. In some embodiments, the replacement values (e.g., “YQ==”) are displayed in the input field 214. Alternatively, the display concealment module 124 may determine to conceal the values in the input field 216 at block 228 (e.g., the character “a” is encrypted as “YQ==” but displayed as “•”)

FIG. 2B illustrates an example environment 200B for a decryption process that may be performed by a host server within the operating environment shown in FIG. 1, according to embodiments of the invention. In particular, the example environment 200B provides a back-end of a process at a host server 130 to conceal sensitive information at a client device 110 in order to be able to prevent onlookers from stealing a user's password or other sensitive information and prevent malicious servers from accessing the password when being sent to the host server 130. The process involves encryption on the front end (e.g., the client device 110) that encrypts each character with a unique key/cipher combination that is updated for each user session between the client device 110 and the host server 130. For example, as illustrated in FIG. 2B, the client device 110 provides the encrypted value information 230, which includes the encrypted values 232 (e.g., “YQ==”) to the host server 130. The encryption orchestration module 142 executes the workflow for the encryption/decryption process for the host server 130. The decryption module 144 then receives the encrypted value information 230 and read the encrypted value(s) at block 242. At block 244, the decryption module 144 decodes the character(s) 246 based on the encryption key associated with the session ID 204 (e.g., entry “a” is deciphered from the encrypted values “YQ==”). Then at block 248, the encryption orchestration module 142 executes an application based on the decoded characters (e.g., determines if the password is correct to allow the user 202 to proceed in the application environment).

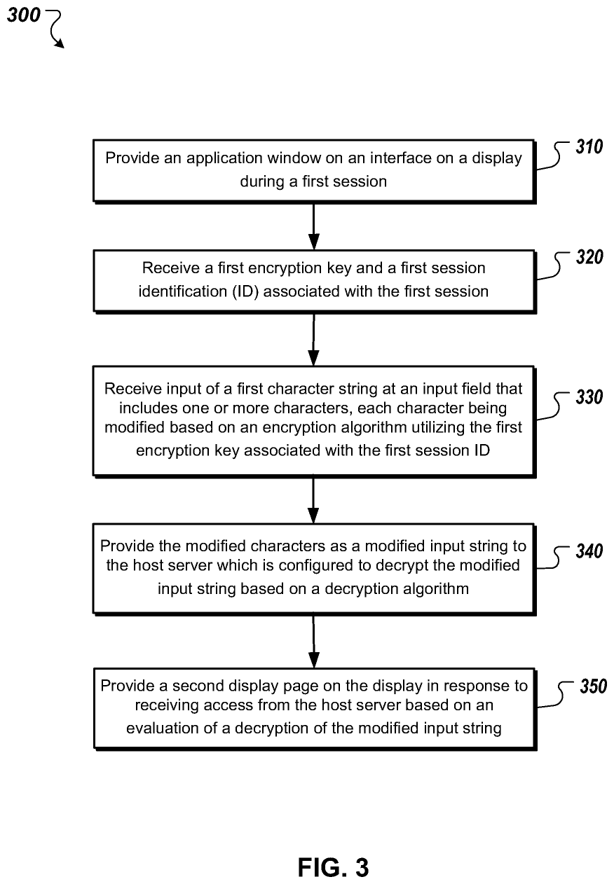

FIG. 3 illustrates a flowchart of an example process 300 for orchestrating encryption of sensitive information, according to embodiments of the invention. In particular, process 300 conceals sensitive information in order to be able to prevent onlookers from stealing a display of a password or other sensitive information and prevent malicious servers from accessing the sensitive information when being sent to a host server. Operations of the process 300 can be implemented, for example, by a system that includes one or more data processing apparatus, such as one or more client device(s) 110 and/or a host server 130 of FIG. 1. The process 300 can also be implemented by instructions stored on computer storage medium, where execution of the instructions by a system that includes a data processing apparatus cause the data processing apparatus to perform the operations of the process 300.

The system provides an application window on an interface on a display during a first session (310). In some embodiments of the invention, the application window is associated with a host server and including an input field for entry of sensitive information at a first display page of the application window. For example, a client device 110 executes an application 112 and includes a user interface that provides an input field for the application 112 that allows a user to enter (e.g., type or by other means) sensitive information (e.g., a password) into the input field.

The system receives a first encryption key and a first session ID associated with the first session (320). For example, after a user 202 initiates the application 112 which executes the front-end encryption orchestration instruction set 120, the application 112 communicates with the host server 130 to initiate the encryption process and generates or determines a session ID to associate with a user's current session (e.g., a first session ID is accessed from the user/session identification database 132 or may be based on the timestamp of the user accessing the system). The host server 130, based on the determined session ID, then also determines and accesses an encryption key to be associated with the first session ID from the encryption database 134. The host server 130 then sends the encryption key and a first session ID to the client device 110.

The system receives input of a first character string at the input field that includes one or more characters, each character being modified based on an encryption algorithm utilizing the first encryption key associated with the first session ID (330). For example, a user typing in password, using the public key, the displayed web page encrypts the entered character and replaces its value by the concealed result. The modified character may be a sign/character that can comprise one or more of the entered characters (e.g., entry “a” or “abc”, etc. is encrypted as “YQ==” but displayed as “•”).

In some embodiments of the invention, during the input of each character of the first character string at the input field, a first modified character is displayed after input of a first character, and after input of a second character a first modified character is displayed and the first modified character is updated. For example, the updated modified character may be replaced with a large dot or asterisk, in addition to a toggle display in which the modified characters would be displayed. Thus, in some embodiments of the invention, there may be an option for the password element to momentarily display each modified character before replacing with a symbol (e.g., the user typed in “abc” which is encrypted as “YQ==”, and may be momentarily displayed as “YQ==”, then displayed as “•” or “•••”, or the like.

In some embodiments of the invention, during the input of each character of the character string at the input field, the display of each character in the input field displays a modified character for each character. For example, the modified characters may be continuously displayed, such that as the user types “abc”, the modified password would stay displayed “YQ==”. In some embodiments of the invention, during the input of each character of the character string at the input field, a symbol is displayed to represent each modified character. For example, the modified characters may be encrypted but displayed as a symbol is displayed that represents the same number of characters that were entered, such that as the user types “abc”, the modified password may be encrypted as a longer character string (e.g., “YQ==”), but displayed as “•••”, which includes the same number of symbol characters as the originally entered text. Additionally, or alternatively, in some embodiments of the invention, during the input of each character of the character string at the input field, a symbol is displayed that represents two or more of the modified characters. For example, the modified characters may be encrypted but displayed as a symbol which is displayed that represents a different number of characters that were entered, such that as the user types “abc”, the modified password may be encrypted as a character string (e.g., “YQ==”), but displayed only as a single symbol “•”.

The system provides the modified characters as a modified input string to the host server which is configured to decrypt the modified input string based on a decryption algorithm (340). For example, once the user sends the form to the backend, the backend will decode the encrypted value using its private key. In some embodiments of the invention, the host server is configured to decrypt the modified input string based on the decryption algorithm utilizing a first decipher key associated with the first session ID.

The system provides a second display page on the display in response to receiving access from the host server based on an evaluation of a decryption of the modified input string (350). For example, the host server 130, after decrypting the password and verifying the authenticity of the decrypted password, accepts the password and grants log in access at the host server. The host server may be a cloud-based web portal or console/server that allows access from client devices that have the correct permissions. Alternatively, if the host server 130 is a gateway server for another entity for password authentication, than the host server 130 may grant access to another server or device associated with the other entity.

In some embodiments of the invention, the encryption orchestration of sensitive information for process 300 may utilize salt cryptography. In an exemplary embodiment, let's say the user is about to type “AA” into the password (input) field at the user interface 114 of the client device 110. To initiate the encryption orchestration of sensitive information process 300, the host server 130 may generate a public and a private key, and send the public key to the client device 110. When the end user 202 types the first letter “A” as the first part of the password sequence, the client device 110 may generate a short random string: “xYtxZ” (e.g., the “salt”), concatenate the password character with the salt: “AxYtxZ”, encrypt the “salted” character with the public key: Encrypt(AxYtxZ, publicKey)=“&!F$ùX+”, and save the mapping table: “0: &!F$ùX+” in memory. After user types in “A”, the password/input field may display a symbol: “•”. When the end user 202 types the second letter “A” as the second part of the password sequence, the client device 110 may then apply a similar process but with a different salt, so it generates a different encrypted string: “!H8_@#K”, and the mapping table in memory is updated to: “0: &!F$ùX+, 1: !H8_@#K”. After user types in the second letter “A”, the password/input field may display two symbols: “••”, to represent the two characters that were entered. The end user 202 may then submit the password entered into the password/input field, and the client device 110 may send a full mapping table to the host server as a password (e.g., “••” is used only for display on screen). The host server 130 decrypts each character one by one using the private key, and reconstructs the full password, thus only the encrypted information is sent between the client device 110 and the host device 130.

In some embodiments of the invention, during a second session different than the first session, the process 300 may further include, receiving, from the host server, a second encryption key and a second session ID associated with the second session, wherein the second encryption key is different than the first encryption key. In some embodiments of the invention, the process 300 may further include receiving input of a second character string at the input field, the second character string including one or more characters, wherein, during the input of each character of the second character string at the input field, each character is modified based on the encryption algorithm utilizing the second encryption key associated with the second session ID. In some embodiments of the invention, the first character string is the same as the second character string, and the modified characters associated with the second character string are different from the modified characters associated with the first character string. For example, a user's password may be “abc”, and during a first user session, as the user types the password “abc” the display shows “123”, but then during a subsequent session, as the user types the password “abc” the display shows “#$%”.

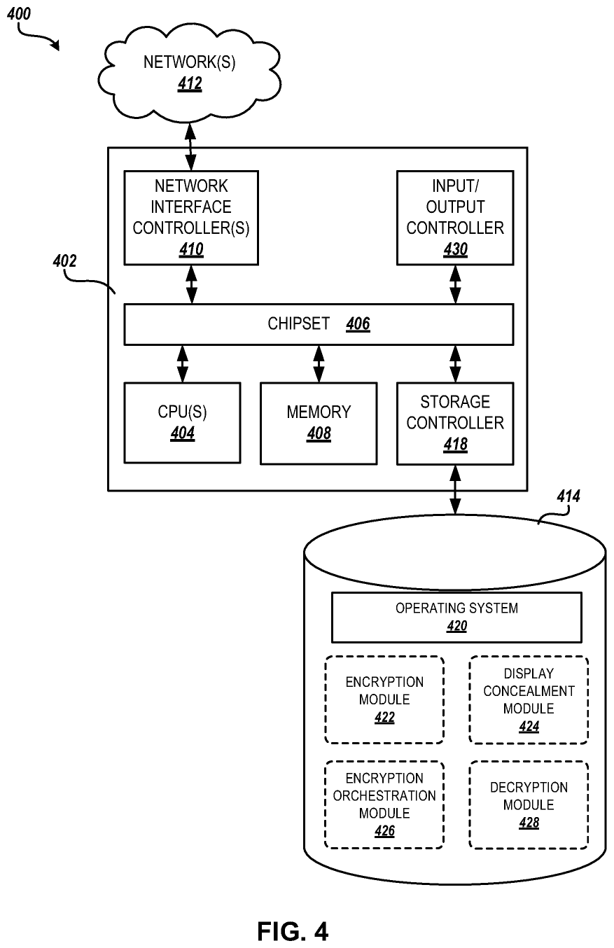

FIG. 4 illustrates an example computer architecture 400 for a computer 402 capable of executing the software components described herein for the sending/receiving and processing of tasks. The computer architecture 400 (also referred to herein as a “server”) shown in FIG. 4 illustrates a server computer, workstation, desktop computer, laptop, a server operating in a cloud environment, or other computing device, and may be utilized to execute any aspects of the software components presented herein described as executing on a host server, or other computing platform. The computer 402 preferably includes a baseboard, or “motherboard,” which is a printed circuit board to which a multitude of components or devices may be connected by way of a system bus or other electrical communication paths. In one illustrative embodiment, one or more central processing units (CPUs) 404 operate in conjunction with a chipset 406. The CPUs 404 can be programmable processors that perform arithmetic and logical operations necessary for the operation of the computer 402.

The CPUs 404 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, or the like.

The chipset 406 provides an interface between the CPUs 404 and the remainder of the components and devices on the baseboard. The chipset 406 may provide an interface to a memory 408. The memory 408 may include a random access memory (RAM) used as the main memory in the computer 402. The memory 408 may further include a computer-readable storage medium such as a read-only memory (ROM) or non-volatile RAM (NVRAM) for storing basic routines that that help to startup the computer 402 and to transfer information between the various components and devices. The ROM or NVRAM may also store other software components necessary for the operation of the computer 402 in accordance with the embodiments described herein.

According to various embodiments, the computer 402 may operate in a networked environment using logical connections to remote computing devices through one or more networks 412, a local-area network (LAN), a wide-area network (WAN), the Internet, or any other networking topology known in the art that connects the computer 402 to the devices and other remote computers. The chipset 406 includes functionality for providing network connectivity through one or more network interface controllers (NICs) 410, such as a gigabit Ethernet adapter. For example, the NIC 410 may be capable of connecting the computer 402 to other computer devices in the utility provider's systems. It should be appreciated that any number of NICs 410 may be present in the computer 402, connecting the computer to other types of networks and remote computer systems beyond those described herein.

The computer 402 may be connected to at least one mass storage device 418 that provides non-volatile storage for the computer 402. The mass storage device 418 may store system programs, application programs, other program modules, and data, which are described in greater detail herein. The mass storage device 418 may be connected to the computer 402 through a storage controller 414 connected to the chipset 406. The mass storage device 418 may consist of one or more physical storage units. The storage controller 414 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 402 may store data on the mass storage device 418 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 418 is characterized as primary or secondary storage, or the like. For example, the computer 402 may store information to the mass storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 402 may further read information from the mass storage device 418 by detecting the physical states or characteristics of one or more particular locations within the physical storage units.

The mass storage device 418 may store an operating system 420 utilized to control the operation of the computer 402. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 418 may store other system or application programs and data utilized by the computer 402, such as encryption module 422 to perform data encryption, a display concealment module 424 for managing concealment an entered password and/or the encrypted password, an encryption orchestration module 426 for managing an encryption/decryption process for a host system, and a decryption module 428 for data decryption, according to embodiments described herein.

In some embodiments, the mass storage device 418 may be encoded with computer-executable instructions that, when loaded into the computer 402, transforms the computer 402 from being a general-purpose computing system into a special-purpose computer capable of implementing the embodiments described herein. These computer-executable instructions transform the computer 402 by specifying how the CPUs 404 transition between states, as described above. According to some embodiments, from the database offloading server(s) 160 perspective, the mass storage device 418 stores computer-executable instructions that, when executed by the computer 402, perform portions of the process 700, for implementing a data location system, as described herein. In further embodiments, the computer 402 may have access to other computer-readable storage medium in addition to or as an alternative to the mass storage device 418.

The computer 402 may also include an input/output controller 430 for receiving and processing input from a number of input devices, such as a keyboard, a mouse, a touchpad, a touch screen, an electronic stylus, or other type of input device. Similarly, the input/output controller 430 may provide output to a display device, such as a computer monitor, a flat-panel display, a digital projector, a printer, a plotter, or other type of output device. It will be appreciated that the computer 402 may not include all of the components shown in FIG. 4, may include other components that are not explicitly shown in FIG. 4, or may utilize an architecture completely different than that shown in FIG. 4.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1-26. (canceled)

27. A computer-implemented method comprising:
at an electronic device having a processor and display:
providing an application window on an interface on the display during a first session, the application window being associated with a host server and comprising an input field for entry of sensitive information at a first display page of the application window;
receiving, from the host server, a first encryption key and a first session identification (ID) associated with the first session;
receiving input of a first character string at the input field, the first character string comprising one or more characters, wherein, during the input of each character of the first character string at the input field, each character is modified based on an encryption algorithm utilizing the first encryption key associated with the first session ID;
providing the modified characters as a modified input string to the host server, wherein the host server is configured to decrypt the modified input string based on a decryption algorithm; and
providing a second display page on the display in response to receiving access from the host server based on an evaluation of a decryption of the modified input string.

28. The method of claim 27 wherein, during the input of each character of the first character string at the input field, a first modified character is displayed after input of a first character and, after input of a second character, a first modified character is displayed and the first modified character is updated.

29. The method of claim 27 wherein, during the input of each character of the character string at the input field, the display of each character in the input field displays a modified character for each character.

30. The method of claim 27 further comprising:
receiving, from the host server, a second encryption key and a second session ID associated with a second session, wherein the second encryption key is different than the first encryption key, and the second session different than the first session; and
receiving input of a second character string at the input field, the second character string comprising one or more characters,
wherein, during the input of each character of the second character string at the input field, each character is modified based on the encryption algorithm utilizing the second encryption key associated with the second session ID.

31. The method of claim 30 wherein the first character string is the same as the second character string, and the modified characters associated with the second character string are different from the modified characters associated with the first character string.

32. The method of claim 27 wherein the host server is configured to decrypt the modified input string based on the decryption algorithm utilizing a first decipher key associated with the first session ID.

33. The method of claim 27 wherein, during the input of each character of the first character string at the input field, each modified character is displayed.

34. The method of claim 27 wherein, during the input of each character of the first character string at the input field, a symbol is displayed to represent each modified character.

35. The method of claim 27 wherein, during the input of each character of the first character string at the input field, a symbol is displayed that represents two or more of the modified characters.

36. A device comprising:
a non-transitory computer-readable storage medium; and
one or more processors coupled to the non-transitory computer-readable storage medium, wherein the non-transitory computer-readable storage medium comprises program instructions that, when executed by the one or more processors, cause the one or more processors to:
provide an application window on an interface on the display during a first session, the application window being associated with a host server and comprising an input field for entry of sensitive information at a first display page of the application window;
receive, from the host server, a first encryption key and a first session identification (ID) associated with the first session;
receive input of a first character string at the input field, the first character string comprising one or more characters, wherein, during the input of each character of the first character string at the input field, each character is modified based on an encryption algorithm utilizing the first encryption key associated with the first session ID;
provide the modified characters as a modified input string to the host server, wherein the host server is configured to decrypt the modified input string based on a decryption algorithm; and
provide a second display page on the display in response to receiving access from the host server based on an evaluation of a decryption of the modified input string.

37. The device of claim 36 wherein, during the input of each character of the first character string at the input field, a first modified character is displayed after input of a first character and, after input of a second character, a first modified character is displayed and the first modified character is updated.

38. The device of claim 36 wherein during the input of each character of the character string at the input field, the display of each character in the input field displays a modified character for each character.

39. The device of claim 36 wherein the program instructions that, when executed by the one or more processors, cause the one or more processors to:
receive, from the host server, a second encryption key and a second session ID associated with a second session, wherein the second encryption key is different than the first encryption key, and the second session different than the first session; and
receive input of a second character string at the input field, the second character string comprising one or more characters,
wherein, during the input of each character of the second character string at the input field, each character is modified based on the encryption algorithm utilizing the second encryption key associated with the second session ID.

40. The device of claim 39 wherein the first character string is the same as the second character string, and the modified characters associated with the second character string are different from the modified characters associated with the first character string.

41. The device of claim 36 wherein the host server is configured to decrypt the modified input string based on the decryption algorithm utilizing a first decipher key associated with the first session ID.

42. The device of claim 36 wherein, during the input of each character of the first character string at the input field, each modified character is displayed.

43. The device of claim 36 wherein, during the input of each character of the first character string at the input field, a symbol is displayed to represent each modified character.

44. The device of claim 36 wherein, during the input of each character of the first character string at the input field, a symbol is displayed that represents two or more of the modified characters.

45. A non-transitory computer storage medium encoded with a computer program, the computer program comprising a plurality of program instructions that when executed by one or more processors cause the one or more processors to:
provide an application window on an interface on the display during a first session, the application window being associated with a host server and comprising an input field for entry of sensitive information at a first display page of the application window;
receive, from the host server, a first encryption key and a first session identification (ID) associated with the first session;
receive input of a first character string at the input field, the first character string comprising one or more characters, wherein, during the input of each character of the first character string at the input field, each character is modified based on an encryption algorithm utilizing the first encryption key associated with the first session ID;
provide the modified characters as a modified input string to the host server, wherein the host server is configured to decrypt the modified input string based on a decryption algorithm; and
provide a second display page on the display in response to receiving access from the host server based on an evaluation of a decryption of the modified input string.

46. The non-transitory computer storage medium of claim 45 wherein, during the input of each character of the first character string at the input field, a first modified character is displayed after input of a first character and, after input of a second character, a first modified character is displayed and the first modified character is updated.
